(19) United States
(12) Patent Application Publication
(10) Pub. No.: US 2021/0255356 A1
(43) Pub. Date: Aug. 19, 2021

(54) DRONE PRESENCE DETECTION

(71) Applicant: The Regents of the University of Colorado, a body corporate, Denver, CO (US)

(72) Inventors: Tam Vu, Denver, CO (US); Richard Han, Boulder, CO (US); Phuc Nguyen, Denver, CO (US); Hoang Truong, Denver, CO (US); Mahesh Kumar Ravindranathan, Boulder, CO (US)

(21) Appl. No.: 16/003,201

(22) Filed: Jun. 8, 2018

Related U.S. Application Data
(60) Provisional application No. 62/516,875, filed on Jun. 8, 2017.

(51) Int. Cl. G01V 8/00; G06K 9/00; G01V 11/00

(52) U.S. Cl. CPC G01V 8/005; G01V 11/00; G06K 9/00335

(57) ABSTRACT

One aspect of the invention provides a device for passive detection of the presence of a drone. The device includes: an antenna; a receiver in communication with the antenna to passively receive wireless signals; and a processor in communication with the receiver and programmed to determine whether a drone is present based on a pattern in the wireless signals emitted from the drone that is correlated with a physical movement of the drone. Another aspect of the invention provides a method for passively detecting the presence of a drone. The method includes: receiving a wireless signal at a device comprising an antenna, a receiver and a processor; and analyzing the wireless signal to determine whether the wireless signal includes a pattern in the signal that is indicative of a physical movement of a drone.

### CROSS-REFERENCE TO RELATED APPLICATION

This application claims the benefit of priority under 35 U.S.C. § 119(e) to U.S. Provisional Patent Application Ser. No. 62/516,875, filed Jun. 8, 2017. The entire content of this application is hereby incorporated by reference herein.

### STATEMENT REGARDING FEDERALLY SPONSORED RESEARCH OR DEVELOPMENT

This invention was made with government support under grant number 1602428 awarded by the National Science Foundation. The government has certain rights in the invention.

### FIELD

The present disclosure relates generally to detecting the presence of a drone in an area.

### BACKGROUND

Drones are increasingly flying in sensitive airspace where their presence may cause harm, such as near airports, forest fires, large crowded events, secure buildings, and even jails. This problem is likely to expand given the rapid proliferation of drones for commerce, monitoring, recreation, and other applications. A cost-effective detection system is needed to warn of the presence of drones in such cases.

Recent work has sought to develop drone detection systems that leverage either microphone, camera, or radar to sense the presence of drones.

Audio-based approaches can be confused by other sounds in noisy environments, have limited range (e.g., less than 50 meters), are limited by advancing technology that is creating quieter drones, and cannot detect drones that employ noise-cancelling techniques.

Camera-based approaches require good lighting conditions, high-quality lenses, and a camera with ultra-high resolution for detecting drones at long distance. Moreover, camera-based approaches may involve multiple cameras to provide 360 degree/omni-directional coverage.

Thermal and infrared imaging cameras are prohibitively expensive and have limited coverage.

Additional work in the drone-detecting area has proposed a variety of radio-frequency (“RF”)-based solutions to drone detection.

One approach suggests monitoring a specific frequency band and assumes that any detected transmitter that is unknown is a drone. This approach suffers from false positives.

Another approach is MAC address collection and analysis; however, it suffers from the ease of bypass by simply spoofing the MAC address.

Radar-based techniques actively transmit RF waves and look for the reflection to determine the presence of a drone. However, active radar techniques are more expensive, involve a transmitter and reflected signals, often introduces interference due to active transmissions, and can generate false positives.

Consequently, there is a need for improved drone-detection systems that are cost-effective and can detect the presence of a drone in varying real-world environments.

### SUMMARY OF THE INVENTION

One aspect of the invention provides a device for passive detection of the presence of a drone. The device includes: an antenna; a receiver in communication with the antenna to passively receive wireless signals; and a processor in communication with the receiver and programmed to determine whether a drone is present based on a pattern in the wireless signals emitted from the drone that is correlated with a physical movement of the drone.

This aspect of the invention can have a variety of embodiments. The pattern can be a unique signature of at least one of: a drone's body vibration identifiable in the wireless signals and a drone's body shifting identifiable in the wireless signals.

At least one of the receiver and the processor can include at least one of: a frequency-based detector programed to detect a maximum frequency peak in a defined range; and a wavelet-based detector programed to detect shifts of the drone's body by computing wavelets at different scales.

The processor can be further programmed to differentiate drone signals from other mobile wireless devices based, at least in part, upon one or more patterns in the wireless signals emitted from the drone that is correlated with a physical movement of the drone.

The processor can be further programmed to differentiate drone signals with an accuracy, precision, and recall above 90 percent at 50 meters based at least in part upon the pattern in the wireless signals emitted from the drone that is correlated with a physical movement of the drone.

The processor can be further programmed to analyze the wireless signals to determine whether the wireless signals contain a pattern that is correlated with a physical movement of the drone. The processor can be further programmed to confirm presence of a drone body movement by confirming presence of at least one selected from the group consisting of: a body shifting movement, a body vibration movement, a coefficient invariance, a temporal consistency, and an event singularity. The pattern can be a unique signature correlated with a drone body movement. The drone body movement can be a body-shifting movement. The drone body movement can be a body-vibration movement. The processor can be further programmed to confirm presence of a drone body movement by confirming presence of a body-shifting movement and a body-vibration movement. The processor can be further programmed to confirm presence of a drone body movement by confirming existence of evidence of a body-shifting movement, a body-vibration movement, a coefficient invariance, a temporal consistency, and an event singularity. The processor can be further programmed to: weight two or more of the evidences to generate an aggregate probability that a drone is present, and determine that a drone is present if the aggregate probability is greater than a defined aggregate probability threshold.

The processor can be further programmed to make a determination based on physical movement of the drone reflected in a wireless signal, wherein the determination is at least one of: localizing the position of the drone, wherein localizing comprises at least one of: identifying a drone to be within a smaller range of a defined area; determining the drone to be located along a particular direction in two- or three-dimensional space; and determining the drone to be located along a particular location in two- or three-dimensional space; determining the speed, direction, velocity, acceleration, and/or attitude of the drone; distinguishing between individual drones; distinguishing between different types of drones; uniquely identifying a drone or drone type; and detecting a number of drones in range.

The processor can be programmed to determine presence without using other methods of identifying the presence, location, direction, velocity, acceleration, or attitude of a drone based on audio, acoustic, video, infrared, thermal, active radar, simple RF detection in a 1 MHz to 6.8 GHz band, MAC-address collection and analysis, frequency of packet communications on uplink or downlink between a drone and its controller, WiDop, passive bi-static radar, and multi-static radar.

The processor can be programmed to determine presence using other methods of identifying the presence, location, direction, velocity, acceleration, or attitude of a drone based on audio, acoustic, video, infrared, thermal, active radar, simple RF detection in a 1 MHz to 6.8 GHz band, MAC-address collection and analysis, frequency of packet communications on uplink or downlink between a drone and its controller, WiDop, passive bi-static radar, and multi-static radar.

Another aspect of the invention provides a method for passively detecting the presence of a drone. The method includes: receiving a wireless signal at a device comprising an antenna, a receiver and a processor; and analyzing the wireless signal to determine whether the wireless signal includes a pattern in the signal that is indicative of a physical movement of a drone.

This aspect of the invention can have a variety of embodiments. The pattern can be a unique signature of at least one of: a drone's body vibration identifiable in the wireless signals; and a drone's body shifting identifiable in the wireless signals. The step of analyzing can further include determining whether the wireless signals contain a pattern that is correlated with a physical movement of the drone. The physical movement can be selected from the group consisting of: a body-vibration movement and a body-shifting movement.

### BRIEF DESCRIPTION OF THE DRAWING FIGURES

For a fuller understanding of the nature and desired objects of the present invention, reference is made to the following detailed description taken in conjunction with the accompanying drawing figures wherein like reference characters denote corresponding parts throughout the several views.

FIG. 1 illustrates the components of a device able to passively detect the presence of a drone with an antenna, a receiver, and a processor, in accordance with various example embodiments.

FIG. 2 illustrates a block diagram of a method for detecting the presence of a drone, in accordance with various example embodiments.

FIG. 3 illustrates an example evidence-based drone detection algorithm.

FIG. 4 illustrates Earth and quad-rotor reference systems.

FIG. 5 illustrates how a drone shifts its body due to the effect from an unexpected wind. The additional force AF is created by speeding up corresponding propellers to balance the drone.

FIG. 6 depicts movement captured by inertial measurement units (IMUs) attached to a BEBOP™ drone.

FIG. 7 depicts an indoor testing environment.

FIG. 8 depicts signals captured by the IMU and from RF.

FIG. 9 depicts frequency distributions of the signal from the IMU (left panel) and RF (right panel).

FIG. 10 depicts an example wavelet analysis of body-shifting detection.

FIG. 11 depicts several testing locations: (a) an urban parking area, (b) a university campus, and (c) a sub-urban setting.

FIG. 12 depicts several drones used during experiments.

FIG. 13 depicts detection accuracy with increasing forms of evidence.

FIG. 14 depicts detection accuracy at different distances.

FIG. 15 depicts detection accuracy at long distances.

FIG. 16 depicts detection accuracy in different environments.

FIG. 17 depicts detection accuracy with different decision times.

FIG. 18 depicts performance across different drones.

FIG. 19 is a confusion matrix from drone classification based on FFT analysis.

### DETAILED DESCRIPTION

The detailed description shows embodiments by way of illustration, including the best mode. While these embodiments are described in sufficient detail to enable those skilled in the art to practice the principles of the present disclosure, it should be understood that other embodiments may be realized and that logical and mechanical changes may be made without departing from the spirit and scope of principles of the present disclosure. Thus, the detailed description herein is presented or purposes of illustration only and not of limitation. For example, the steps recited in any of the method descriptions may be executed in any order and are not limited to the order presented.

Moreover, for the sake of brevity, certain sub-components of individual components and other aspects of the system may not be described in detail herein. It should be noted that many alternative or additional functional relationships or physical couplings may be present in a practical system. Such functional blocks may be realized by any number of components configured to perform specified functions.

The disclosure includes a device for passive detection of the presence of a drone that is configured to detect whether a drone is present based on a pattern in the wireless signals that is correlated with a physical movement of the drone. By passively detecting such wireless signals, the device does not produce its own interference with the signals, and is capable of detecting drones at long distances without noise interference, lighting issues, or increased expense that occur with other methods of detection. Furthermore, the device provides non-line-of-sight radio-frequency (“RF”) detection in the presence of occlusions, such as buildings and the device is capable of detecting multiple drones in the same vicinity at the same time.

In an example embodiment, a device for passive detection of the presence of a drone includes: an antenna; a receiver to passively receive wireless signals; and a processor configured to determine whether a drone is present based on a pattern in the wireless signals that is correlated with a physical movement of the drone. In an example embodiment, the pattern could be a unique signature of a drone's body vibration and body shifting in the wireless signal transmitted from a drone.

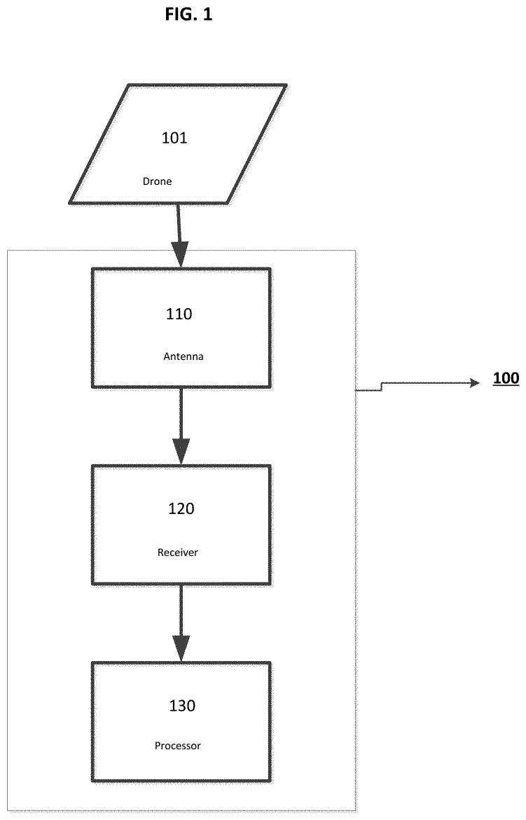

For example, and with reference to FIG. 1, a device 100 for passive detection of the presence of a drone 101 can include an antenna 110, a receiver 120, and a processor 130. Antenna 110 may be configured to receive wireless signals from drone 101 and communicate the wireless signals to receiver 120. Receiver 120 may be configured to down-convert and/or filter the wireless signals and pass a received signal to the processor 130.

The drone 101 can be an unmanned aerial vehicle, i.e., an aircraft without a human pilot aboard. In an example embodiment, the drone 101 may be a four rotor drone. For example, the drone 101 may sold under a variety of trademarks including: PARROT BEBOP™, PROTOCOL DRONIUM ONE SPECIAL EDITION™, SKY VIPER®, SWIFT STREAM™, PARROT AR DRONE®, PROTOCOL GALILEO STEALTH™, and DJI PHANTOM™. In other example embodiments, the drone 101 may include any suitable number of rotors (one or more). Thus, the drone 101 may be a helicopter in one embodiment. In another embodiment, the drone 101 may be an airplane. In another embodiment, the drone 101 may comprise between four and eight rotors. Moreover, in an example embodiment, the drone 101 is any flying object capable of being remotely controlled and emitting wireless signals. In an example embodiment, the drone 101 emits wireless signals to a controller (not pictured), e.g., a hand-held or body-worn remote control device. In another embodiment, the drone 101 emits wireless signals from a camera. Moreover, the drone 101 may emit wireless signals intended for any suitable receiver and/or purpose.

In various embodiments, the wireless signals may be radio-frequency signals. In various embodiments, the wireless signals may be infrared (“IR”) signals. In various embodiments, the wireless signal may be BLUETOOTH® signals (e.g., using short-wavelength UHF in the ISM band from 2.4 to 2.485 GHz). In various embodiments, the wireless signals may be on licensed WI-FI® frequency bands (e.g., the 2.4 GHz UHF and 5.8 GHz SHF ISM radio bands), or unlicensed frequency bands. In various embodiments, the wireless signals may be satellite signals. In various embodiments, the wireless signals may be microwave signals. It should be appreciated that the wireless signals may be any kind of wireless signals that are broadcast from a drone.

In an example embodiment, the detection of the wireless signals is limited to a specific channel. For example, the system may eavesdrop on a specific communication channel. Drones usually operate at predefined radio frequency channels. For example, WI-FI® drones communicate within 14 communication channels: 2.412 GHz, 2.417 GHz, 2.422 GHz, 2.427 GHz, 2.432 GHz, 2.437 GHz, 2.442 GHz, 2.452 GHz, 2.457 GHz, 2.462 GHz, 2.467 GHz, 2.472 GHz, 2.484 GHz. In another example, the predefined radio frequency channels include WI-FI® and Global System for Mobile communications (GSM) channels. However, this can be generalized for other communication standards as well.

In an example embodiment, the device 100 traces all the possible channels of radio frequency communication and observes the received wireless samples (as described herein) to check whether these signals are from a drone or from other RF devices (e.g., mobile phone, laptop, static access points (APs), or mobile APs and so on). In an example embodiment, the tracing approach can be similar to that used in spectrum sensing in Cognitive Radio. In another example embodiment, the system is configured to sense the channels in an automated way (e.g., spectrum sensing). A receiver, in particular, can sweep through different radio frequencies to identify which frequencies are being used. In accordance with an example embodiment, the device 100 can be programmed to analyze the received signal at these frequencies to detect the physical signature of the drone (body shifting and body vibration). Moreover, the system may be programmed to detect drones that operate with different protocols over the same wireless frequency bands (e.g., over the same unlicensed Wi-Fi frequency bands or over the same non-Wi-Fi frequency bands). This can be particularly useful for detecting a drone that was built to use non-licensed frequency bands and communication protocols, where the system can scan all Industrial Scientific and Medical (ISM) or other bands. This can be particularly useful where someone designs a drone to avoid typical detection mechanisms.

In an example embodiment, the antenna 110 is a directional antenna. The directional antenna may be configured to improve the gain of detection of the wireless signals in a particular direction. In one example embodiment, the orientation of the directional antenna is fixed. In another example embodiment, the directional antenna is physically moved to monitor multiple portions of the sky. In another example embodiment, the system and method may integrate automated antenna steering/beam forming to enhance the virtual orientation of the antenna 110 and detection of a drone 101. In another example embodiment, multiple directional antennas are used in parallel to monitor a greater portion of the sky than possible with one directional antenna. Moreover, the antenna 110 can be an omni-directional antenna.

In an example embodiment, the system 100 is configured to passively receive wireless signals and to determine whether a drone is present within a range. For example, the receiver and processor may include at least one of: a frequency-based detector programmed to detect the maximum frequency peak in a particular range (e.g., 50-220 Hz) to indicate drone body vibration; and a wavelet-based detector to capture the sudden shifts of the drone's body by computing wavelets at different scales from the temporal RF signal.

In an example embodiment, the receiver 120 is configured to receive the wireless signal and convert the wireless signal into digital data for analysis by the processor 130.

In an example embodiment, the processor 130 is programmed to distinguish the wireless signals emitted by a drone from both environmental noise and from RF signals from moving sources that are not drones. In an example embodiment, the processor is configured to differentiate drone wireless signals from wireless signals from other mobile devices. The processor may be configured to do this with a high accuracy e.g., above 90 percent accuracy, precision, and recall with distance up to 600 meters.

In an example embodiment, the processor 130 is configured to determine whether a drone is present based on a pattern in the wireless signals that is correlated with a physical movement of the drone. In an example embodiment, the pattern could be a unique signature of a drone's body vibration and body shifting in the wireless signal transmitted from a drone.

In an example embodiment, the processor 130 can employ an evidence-based drone detection algorithm to determine if a drone is present. The algorithm can first involve gathering multiple types of evidence relating to physical drone movements including: detection of a moving object, detection of drone body shifting, detection of a coefficient invariance, the detection of temporal consistency, the detection of an event singularity, and the detection of a body vibration. In various example embodiments, the algorithm can detect one of the types of evidence to confirm a drone's presence. In various example embodiments, the algorithm can detect two of the types of evidence to confirm a drone's presence. In various example embodiments, the algorithm can detect between three and five types of evidence to confirm a drone's presence. In various example embodiments, the algorithm can be configured to detect all types of evidence to confirm a drone's presence. In various example embodiments, the algorithm can be configured to detect a drone body shifting and a drone body vibration to confirm a drone's presence. The algorithm may detect any combination of the types of evidence to confirm whether a drone is present.

The first type of evidence that a drone is present in the monitored range is the presence of a moving object emitting RF signals. Of course, this evidence is merely suggestive of the probability that a drone might be present. In particular, here, the detection of a moving object emitting RF signals not only could indicate the presence of a drone, but could indicate the presence of a mobile phone on a walking person or in a moving car in the monitored range. But this evidence, potentially combined with other evidence can be used to determine the presence of a drone with increased accuracy, precision, and recall.

In an example embodiment, the processor 130 is configured to calculate the standard deviation of the environment (i.e., a standard deviation when no drone or moving wireless signal emitting object is present). This environment standard deviation may be determined at initialization of the device, periodically, or at any other suitable time. This environment standard deviation represents the received signal changes caused by electronic noise. The environment standard deviation will therefore likely reflect a received signal following a Gaussian distribution with a zero mean after DC removal. This environment standard deviation can be stored and used as a reference as described herein.

During drone monitoring, the processor 130, in one example embodiment, is programmed to calculate a standard deviation of the received wireless signal and compare that drone monitoring standard deviation with the environment standard deviation. In accordance with various aspects of the disclosure, the wireless signals received from a drone can follow the distribution of multipath fading (a log-normal, Ricean, or Rayleigh distribution). Thus, processor 130 is configured to detect the difference between the environment standard deviation and the drone monitoring standard deviation, and upon said detection, confirm that there is evidence of a moving object with an active radio transmission in the range being monitored.

The second type of evidence of the presence of a drone, in an example embodiment, is based on body shifting. Body shifting describes a sequence of discrete drone movement events that are related to the drone control system. The body shifting refers to small movements as the drone hovers or as it moves along a route, as opposed to the gross movement that is the overall movement as the drone traverses the route. In an example embodiment, the drone's body may shift due to wind and/or as a rebalancing effort directed by the drone's control system. In another example embodiment, the drone's body may shift due to the change of the body orientation and direction when flying. A body shift may occur because of any combination of environmental or directional events, in accordance with various embodiments. In response to these kinds of body movements, the drone's rotors may change their speeds to account for the multitude of unbalancing forces until the drone returns to an equilibrium state. These discrete movements are physically distinctive and have a unique pattern compared to translative movements such as that of a moving automobile.

The drone body shift movement causes a change in the wireless signals emitted from the drone. Thus, in an example embodiment, the processor 130 is configured to analyze the wireless signals received from the as-yet-unknown source and to detect whether there exist body-shift-induced changes in the wireless signals.

It is noted that the speed (i.e., how fast the drone shifts) and amplitude (i.e., how far drone moves) of the shifting may vary from one movement of the drone to the next movement of the drone. Therefore, a two-step analysis can be performed for this evidence. If both step A and step B are satisfied, the processor 130 is configured to determine that this second type of evidence of the presence of a drone is confirmed.

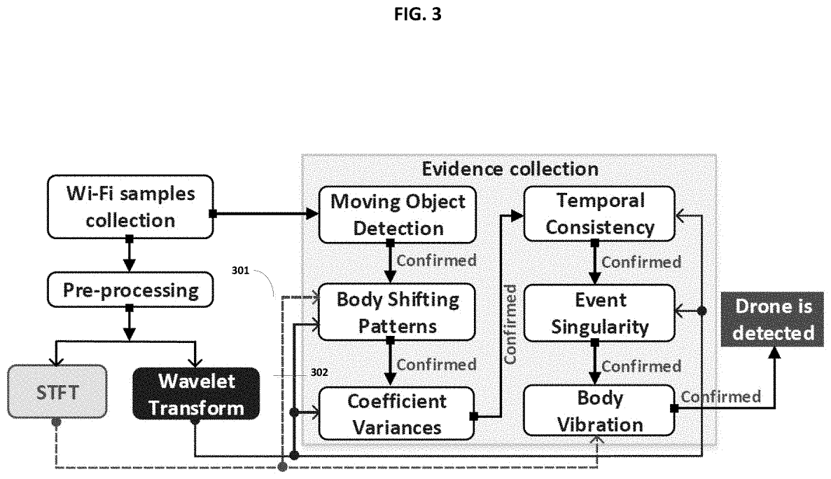

With reference generally to FIG. 3, in an example embodiment, in step A 301, the processor 130 is programmed to detect a specific range of speeds (i.e., frequency), by acquiring the frequency of the body shifting. An example method is described in the “Drone-Body-Shifting Detection” subsection of the Working Example. It is noted, that although example methods have been described herein, the noise in the environment, the drone size, transmission frequencies of interest, and other such factors may change the weight given to any factors or methods described with respect to this step A, or indeed with respect to any of the types of evidence and the relative weight give to each type of evidence. If the frequency is less than a predetermined frequency, then step A is satisfied. In various example embodiments, the predetermined frequency for confirmation is less than 10 Hz. In various example embodiments, the predetermined frequency for confirmation is less than 12 Hz. In various example embodiments, the predetermined frequency for confirmation is less than 15 Hz. In various example embodiments, the predetermined frequency for confirmation is less than 20 Hz. It should be appreciated that the predetermined frequency for confirmation may be set to any suitable frequency at which body shifting can be detected.

Again with reference to FIG. 3 generally, in an example embodiment, in step B 302, the processor is programmed to amplify and process the signal using different signal processing techniques to generate a waveform of the body shifting. One example signal processing technique that could be used is performing a wavelet transformation on the wireless signals emitted by the drone to generate a waveform of the body shifting. Processor 130 can be programmed to compare this waveform of the body shifting to a template. The template can be any waveform that is representative of the unique body shift movement of one or more drones. In an example embodiment, the template is a wavelet representative of the body shift movement. In another example embodiment, the template is a Mexican Hat wavelet. The Mexican Hat wavelet has a similar waveform to drone body shifting caused waveform. The wave form may be compared to the template by calculating the coefficient between the two using the Dynamic Time Wrapping technique. (See T. Giorgino, “Computing and visualizing dynamic time warping alignments in R: The dtw package”, 31(7) Journal of Statistical Software 1-24 (2009); and P. Tormene et al., “Matching incomplete time series with dynamic time warping: An algorithm and an application to post-stroke rehabilitation”, 45(1) Artificial Intelligence in Medicine 11-34 (2009).) If the coefficient between the two is less than a preset coefficient threshold, then the waveform is similar to the template and step B is satisfied. In various example embodiments, the preset coefficient threshold is determined by the practical possible range of body-shifting amplitude. In various example embodiments, the preset coefficient threshold may be between 0 and 1. In various example embodiments, the preset coefficient threshold may be between 0.2 and 0.8. In various example embodiments, the preset coefficient threshold may be between 0.4 and 0.8. In various example embodiments, the preset coefficient threshold may be between 0.6 and 0.8. In various example embodiments, the preset coefficient threshold may be around 0.7. It should be appreciated that the preset coefficient threshold may be set to any coefficient that would be suitable for confirming similarity of the waveform to the template.

Where steps A and B are satisfied, confirming that the frequency falls within a specific range and the coefficient is under a preset coefficient threshold, the processor 130 has therefore detected this wavelet pattern and confirmed this second evidence of a drone being present.

The third type of evidence is a coefficient invariance. This type of evidence confirms that the body shifting is a discrete event that is similar to the template. Due to the nature of body-shifting events, two or more consecutive body shifting motions are unexpected and non-uniform events triggered by various environmental and electronic artifacts. Therefore two or more consecutive body shifting motions are not expected to be similar to one another. As one of the wavelet transformation properties, coefficient invariance can be used to confirm if a template (i.e., body shifting signature on RF domain) is present on a segment of received signal once and only once. The length of the segment and the selection of the segment can vary based on the sampling rate of the receiver, the duration of the expected body shifting signature, or the amount of time the receiver can capture RF signals from the drone. In an example embodiment, the segment is 5 seconds to 30 seconds, however any suitable segment time could be used. If the coefficient magnitude monotonically increases across multiple body shifting events as the transformation scale increases, the processor 130 may confirm the presence of a drone. In various example embodiments, the coefficients of at least two cycles are compared. In various example embodiments, the coefficients of at least three cycles are compared. In various example embodiments, the coefficients of at least four cycles are compared. It should be appreciated that the processor 130 may rely on any multiple number of body shifting cycles to make a confirmation that this third type of evidence of the presence of a drone is present.

The processor 130 may also rely on temporal consistency as a fourth type of evidence capable of confirming the presence of a drone. The temporal consistency evidence is determined by observing the spread of the signal at different sampling rates. As the sampling rate reduces, the coefficient of the noise decays because the wireless samples that represent the surges are reduced or disappear. Let t₁[s] be the spread of the signal at sampling rate fₛ₁, t₂[s] be the spread of the signal at sampling rate fₛ₂, fₛ₁>fₛ₂. t₁[s] and t₂[s] can be approximated from the spread of the wavelet coefficient. If the spread of the wavelet transformation results at multiple sampling rates are remained unchanged (|t₁−t₂|<Δt), the processor 130 may be configured to confirm that this evidences a drone is present. For example, if t₁=1 [s], t₂=1.1 [s], Δt=0.5 [s], then |t₁−t₂|=0.1 [s]<0.5 [s]. Note that wavelet decomposition technique is used to extract the wavelet coefficient at different sampling rates.

The fifth type of evidence on which a processor may rely is an event singularity. As the fluctuation of the drone is in the wavelet pattern, the direction of fluctuation is unique. The direction of the body shifting can be obtained by the sign of extremum of the wavelet coefficients. In an example embodiment, the direction is changed between two consecutive extrema at the same frequency with that of the body shifting at different levels of decomposition. In other words, if there is body shifting, in an example embodiment, there are direction changes. If the sign of the extremum coefficient alternates while the magnitudes of coefficients remain similar, the processor 130 may be configured to confirm the existence of this fifth type of evidence of the presence of a drone.

A drone's body vibrates within a certain frequency range as a result of the vertical, longitudinal, and lateral vibrations caused by the drone's propellers, creating the sixth type of evidence. In various example embodiments, the drone's body vibrations may be caused by the engine operating speed. In various example embodiments, the drone's body vibrations may be caused by the rotation of the drone's propellers. In various example embodiments, the body vibration may be detected in wireless signals emitted from the drone. The body vibrations may be detectable between 50 Hz and 220 Hz in the wireless signals. In various example embodiments, the frequency of the body vibration may be detected between 100 Hz and 220 Hz. It should be appreciated that the frequency of the body vibration may be between any two frequencies known in the art to be frequencies for the vibration of a drone body. The processor 130 can be programmed to detect this frequency of body vibration to determine whether a drone is present through use of a short-time Fourier Transform analysis (STFT). One example embodiment is described in the “Drone-Body-Vibration Detection” subsection of the Working Example. In an example embodiment, the drone body vibration generates the variation in the wireless samples at a certain frequency range. For example, a Fast Fourier Transform (FFT) technique can be used to analyze the power of different frequencies from the collected wireless signals. As the variation of the signal follows the vibration patterns of the drone, the frequency that has strongest power distribution over the FFT result, in an example embodiment, is considered as the vibration frequency of the drone. If the frequency of the detected body vibration is close to the vibration frequency of any drone in a drone-vibration-signature database, then processor 130 confirms the existence of this sixth type of evidence of the presence of a drone in the monitored range.

The second evidence can show the similarity of the signal representing body shifting and the template, while the third and fourth evidences reduce the likelihood of false positives due to noise in the RF domain, and the fifth evidence can confirm that the change of body-shifting behavior should cross-interleave the balance state.

In various example embodiments, the algorithm used by the processor 130 may be weighted to favor certain types of evidence over others. In an example embodiment, the processor is configured to weight the evidences to focus more on the impact of the drone's body vibration in detection. In various embodiments, the algorithm may place a heavy weight on the drone-body-shifting evidence. In various embodiments, the algorithm may place a heavy weight on the drone-body-vibration evidence. In various embodiments, the algorithm may place a heavy weight on both the drone-body-shifting and the drone-body-vibration evidence. It should be appreciated that the higher the number of types of evidence being considered, the higher the device's accuracy at detecting the presence of a drone. The false positive rate diminishes and precision rises as more evidences are integrated. In various example embodiments, the precision of the system may be as low as 78.9% with only one part of the evidence considered, and increases successively once the first five forms of evidence are considered. In various example embodiments, the precision of the system may increase to 92.2% when all six types of evidence are considered.

In an example embodiment, processor 130 is programmed to determine an aggregate probability that a drone is present based on one or more of the five types of evidence. Where the aggregate probability exceeds a preset drone presence probability threshold (e.g., 90%), then processor 130 can be configured to determine that a drone is present. Although set forth herein as a 90% threshold, any other suitable threshold may be used. Processor 130 may generate an output, such as an alert or other signal, to indicate that it has detected a drone. FIG. 3 illustrates an example evidence-based drone detection algorithm.

In various example embodiments, the processor 130 may be located remotely from the antenna 110 and receiver 120. In such example embodiments, there may be a link between the receiver 120 and the processor 130 that allows the wireless signal to be communicated from the receiver 120 to the processor 130. In various example embodiments, the link may be a wire. In various example embodiments, the link may be wireless. It should be appreciated that, in example embodiments where the processor 130 is remotely located from the antenna 110 and receiver 120, the link between the receiver 120 and the processor 130 may be any type of link known in the art to allow communication of the wireless signal between the receiver 120 and the processor 130.

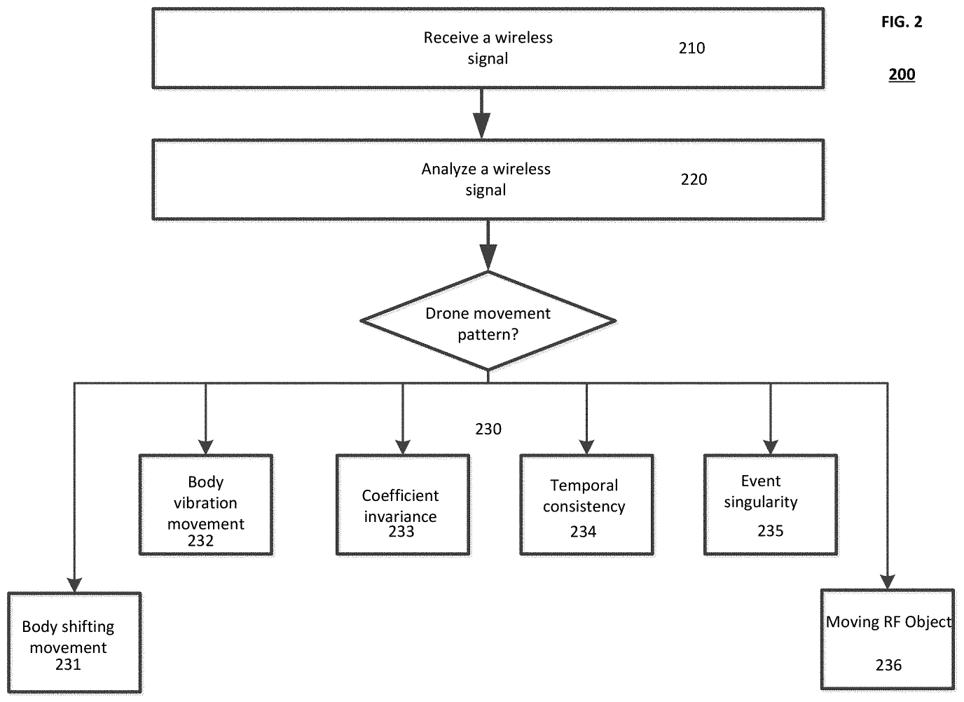

FIG. 2 is a block diagram of an example method 200 for passively detecting the presence of a drone. The method can include: receiving a wireless signal 210; and analyzing the wireless signal 220 to determine whether the wireless signal includes a pattern in the signal that is indicative of a physical movement of a drone. The method 200 may further comprise determining 230, based on the analyzing, whether the evidence indicates the presence of a drone.

In various example embodiments, the step of analyzing the wireless signal 220 may further comprise detecting the presence of one or more of the types of evidence indicative of the presence of a drone. In various example embodiments, the evidence may be in the form of a pattern in the wireless signal indicative of drone movement 230. In various example embodiments, the pattern may be indicative of a body-shifting movement 231. In various example embodiments, the pattern may be indicative of a body-vibration movement 232. In various example embodiments, the pattern may be indicative of a coefficient invariance 233. In various example embodiments, the pattern may be indicative of a temporal consistency 234. In various example embodiments, the pattern may be indicative of an event singularity 235. In various example embodiments, the pattern may be indicative of a moving RF object 236. In various example embodiments, the pattern may be indicative of more than one type of evidence 231-236.

In various example embodiments, the step of analyzing the wireless signal 220 may further comprise using an algorithm to weigh different types of evidence detected in the wireless signal to determine the likelihood of a drone presence. In various example embodiments, the algorithm may weigh the presence of a pattern in the wireless signal that is indicative of a body shifting movement 231 or a body vibration movement 232 more heavily than the presence of a pattern indicating a coefficient invariance 233, a temporal consistency 234, an event singularity 235 or a moving RF object 236. For example, if a pattern is detected in the wireless signal that relates to a coefficient invariance 233, but no other type of evidence is detected, the algorithm may conclude that no drone is present. Alternatively, for example, if a pattern is detected in the wireless signal that relates to a body-shifting movement 231 but no other type of evidence is detected, the algorithm may conclude that a drone is present. In various example embodiments, the algorithm may be configured to confirm the presence of a drone if a pattern indicative of a body-shifting movement 231 or a body-vibration movement 232 is present. In various example embodiments, the algorithm can be configured to confirm the presence of a drone if a pattern indicative of a body shifting movement 231 or a body vibration movement 232 is present in addition to a pattern indicative of a coefficient invariance 233, a temporal consistency 234, an event singularity 235, and/or a moving RF object 236. In various example embodiments, the algorithm can be configured to confirm the presence of a drone only if all forms of evidence 231-236 are present.

In various example embodiments, the method for passively detecting the presence of a drone may be utilized with a device for passively detecting the presence of a drone 100.

In accordance with various example embodiments, the system and method may further comprise making other determinations (other than determining the presence of a drone) based on physical movement of the drone as reflected in a wireless signal.

For example, the system and method may be configured to localize the position of the drone based on physical movement of the drone as reflected in a wireless signal. Although the system described herein identifies that a drone is present within a particular area (based on the range of detecting the presence of a drone), position localization may include any system of more accurately identifying the drone's location. For example, the drone may be identified to be within a smaller range (tighter circle, etc.) of the particular area, along a particular direction in three dimensional space (as may be identified with the directional antenna), or more precisely at a two or three dimensional location in space. Any such localization may be relative to the antenna or to any other reference frame. Any of these determinations may, in an example embodiment, occur based on physical movement of the drone as reflected in a wireless signal from the drone.

In another example embodiment, the system and method may be configured to detect other aspects of the drone beyond merely its presence, such as its speed and direction based on the physical movement of the drone as reflected in a wireless signal from the drone. For example, merely based on the impact on the RF signal from the drone, the location of the drone may be identified, and upon additional sampling of the location of the drone, the direction the drone is flying can be identified. Furthermore, knowing the sample rate, the velocity and/or acceleration of the drone can be determined. Moreover, the location, direction, velocity, acceleration and/or attitude (yaw, pitch, roll) of the drone can be detected based on the physical movement of the drone that is reflected in a wireless signal from the drone in any suitable way.

In an example embodiment, the system and method may be configured to distinguish between individual drones and/or between different types of drones based on physical movement of the drone as reflected in a wireless signal from the drone. For example, each drone type may have a different weight, control algorithm, responsiveness, etc., that cause it to have a unique signal characteristic representative of its physical movement. Thus, a first drone may have a different signal characteristic (representative of its physical movement) from a second drone, wherein the first and second drone are different models of drones. Even with the same type/model of drone, each individual drone may have a different weight of payload, a different distribution of payload, a manufacturing variation, an operational difference (flying speed or aggressiveness), a local environmental difference, a mechanical break, or the like that results in a different signal characteristic (representative of its physical movement) between two drones.

Based on this different signal characteristic, the system can be configured to identify one drone as unique from another drone. For example, each uniquely identified drone can be assigned a unique id number. In another example, the signal characteristic of a drone can be compared to the signal characteristic of known drones or drone types, which may be recorded in a table or database of known drone characteristics, for the purpose of uniquely identifying a drone or drone type.

In another example embodiment, the system and method may be configured to detect the number of drones in range based on the identification of each individual drone in the range, based on physical movement of the drone as reflected in a wireless signal from the drone.

In an example embodiment, the system and method are exclusive of other methods for identifying the presence (or location, direction, velocity, acceleration, or attitude) of a drone based on audio, acoustic, video, infrared, thermal, active radar, simple RF detection in the 1 MHz to 6.8 GHz band, MAC address collection and analysis, the frequency of packet communications on the uplink and downlink between a drone and its controller, non-coherent radar (e.g., WiDop as described U.S. Pat. No. 9,268,008), passive bi-static radar, multi-static radar, and the like techniques. In another example embodiment, the systems and methods described herein can be used in combination with these techniques

In an example embodiment, the system and method are capable of identifying drones at distances greater than 50 meters, between 0 and 1200 meters, from 1 to 100 meters, from 100 to 200 meters, from 200 to 300 meters, from 400 to 500 meters, from 500 to 600 meters or any combination of these distances. Moreover, the system and method are capable of identifying a drone at any distance suitable for adequate detection of the wireless signal emitted by the drone.

Embodiments of the invention can communicate or be integrated with one or more anti-drone weapons (e.g., in military, defense, or other security applications) such as projectile-based (e.g., bullet or missile), energy-based (e.g., laser), RF-jamming, and the like.

In describing the present disclosure, the following terminology will be used.

The singular forms “a,” “an,” and “the” include plural referents unless the context clearly dictates otherwise. Thus, for example, reference to an item includes reference to one or more items.

The term “ones” refers to one, two, or more, and generally applies to the selection of some or all of a quantity.

The term “plurality” refers to two or more of an item.

The term “about” means quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art.

The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items.

The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

It should be understood, however, that the detailed description and specific examples, while indicating exemplary embodiments of the present invention, are given for purposes of illustration only and not of limitation. Many changes and modifications within the scope of the instant invention may be made without departing from the spirit thereof, and the invention includes all such modifications. The corresponding structures, materials, acts, and equivalents of all elements in the claims below are intended to include any structure, material, or acts for performing the functions in combination with other claimed elements as specifically claimed.

The scope of the invention should be determined by the appended claims and their legal equivalents, rather than by the examples given above. For example, the operations recited in any method claims may be executed in any order and are not limited to the order presented in the claims. Moreover, no element is essential to the practice of the invention unless specifically described herein as “critical” or “essential.”

### WORKING EXAMPLE

### Fundamental Aerodynamics and Physical Signatures of Drones

### Drone Movement and Control Background

Drones or micro air vehicles (MAVs) can be made from a form of helicopter, an airplane, a multi-rotor, or even a balloon. Helicopter and multi-rotors are the most common drones due to simplicity of manufacturing. A multi-rotor has multiple rotors with a much simpler flying-control mechanism compared to that of a helicopter. Instead of changing its wing's pitch and speed using a complex rotor as found in helicopters to maintain balance and maneuver, a multi-rotor operates by simply changing its motors' speed. Therefore, no complex mechanical parts is required. Partly due to this simplicity, multi-rotor-based drones are much more popular than their counterpart helicopters. Because it has multiple similar rotors arranged symmetrically, a multi-rotor can keep its balance more easily even when it carries additional load (e.g., camera, packages). The change in the center of mass can be tolerated by simply adjusting the rotors' speed. These advantages of multi-rotor design become even more significant in small-sized drones because integrating sophisticated controlling mechanics as in a helicopter requires a large form-factor, increasing cost and size of the drone's footprint. Therefore, most of today's commercial drones are of the multi-rotor type and the same trend is predicted for the near future.

### Drone Equilibrium Conditions

The popular designs of multi-rotors include 4-, 6-,and 8-rotors, which are naturally termed quad-copter, hexa-copter and octo-copter respectively. The most popular is the quadrotor, which has four similar propellers arranged in either “x” configuration or “+” configuration with equal distance from its the center of mass. The rotation direction of each propeller depends on its relative position.

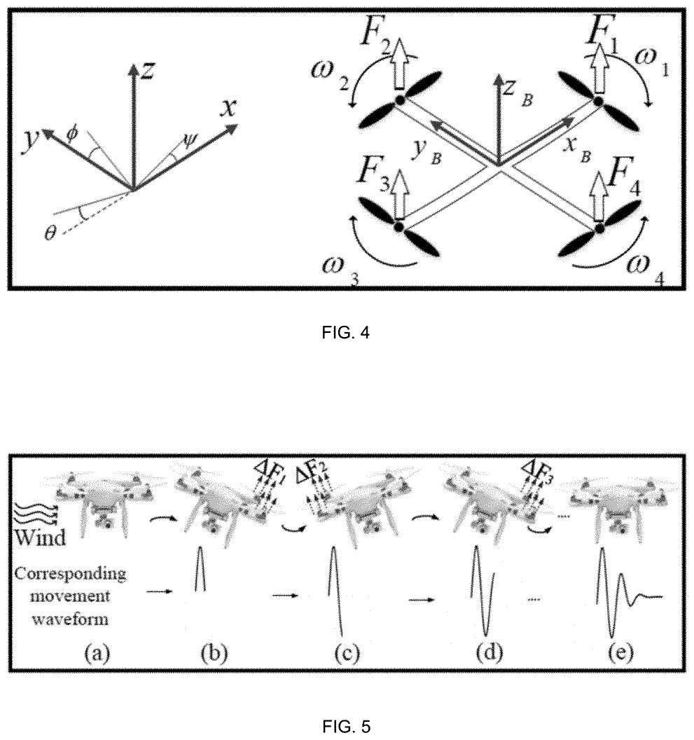

Let the indexes of the propellers be numbered sequentially from #1 to #4. If the propeller #1 rotates clockwise, for example, propellers #2 and #4 will rotate counterclockwise while propeller #3 will rotate clockwise as illustrated in FIG. 4. To facilitate analysis in the remaining sections of this example, let ωᵢ with i=1 . . . n the rotation speed of each propeller. Without losing generality, this example focuses on analyzing quadrotors (n=4).

Let Fᵢ with i=1 . . . 4 be the forces generated by the propellers i and m be the mass of the quadrotors. Because the quadrotor is symmetric, if L is the distance between the center of the quadrotor and each propeller, the moment generated by each propeller is calculated by Mᵢ=L*Fᵢ. In an ideal environment, in order to keep balance and remain in equilibrium state, the quadrotor must obey these four physical conditions:

TABLE 1

| | | |
|---|---|---|
| (A) | Σᵢ₌₁⁴ Fᵢ = −mg | Equilibrium of forces |
| (B) | Σᵢ₌₁⁴ Fᵢ ∥g | Equilibrium of directions |
| (C) | Σᵢ₌₁⁴ Mᵢ = 0 | Equilibrium of moments |
| (D) | (ω₁ + ω₂) − (ω₃ + ω₄) = 0 | Equilibrium of rotation speeds |

If one or more of those conditions are violated, the quad-rotor will leave equilibrium state and start making movement as depicted in FIG. 4. Two reference systems are used to represent the position and orientation of the quadrotor. The inertial reference system, i.e., the Earth frame (denoted x, y, and z axes) provides the absolute linear position of the quadrotor and the quadrotor reference system, i.e. the body frame (denoted x_{B}, y_{B}, z_{B}-axes) gives the angular position with three Euler angles. Roll angle (ϕ), Pitch angle (θ) and Yaw angle (ψ) determines the rotation of the quadrotor around the x, y, and z axes, respectively.

### Drone Maneuvering Conditions

Any movement of a quadrotor can be created by a combination of four basic movements: roll rotation, pitch rotation, yaw rotation and altitude change. Each of these movements is created by briefly violating the above equilibrium conditions by applying proper angular speeds to each propeller, ω_{1 . . . 4}. For example, to create a roll rotation, ω_{1 . . . 4} must be applied such that (ω₁+ω₂)−(ω₃+ω₄)≠0. Similarly, to generate a pitch rotation, the drone needs to change the angular speeds of different rotors such that (ω₁+ω₂)−(ω₃+ω₄)≠0. To move the drone up and down, the rotation speeds should be changed to adjust the thrust force F so that Σᵢ₌₁⁴Fᵢ≠−mg.

### Body Shifting and Body Vibration as Drone's Physical Signatures

Many different controllers have been introduced in the literature following aforementioned principles, including proportional-integral-derivative (PID), back-stepping, nonlinear H∞, linear-quadratic regulator (LQR), and nonlinear controllers with nested saturation, to stabilize and maneuver drones. Beside taking the desired direction as inputs, these controllers also need to take into account impacts of the unpredictable environments, such as wind, and the inaccuracy of its sensors and actuators. Because these factors are nondeterministic and occur often, the controller needs to frequently react to and compensate for them, causing undesirable physical movement on the drone. In particular, the undesirable movements can be the result of the controller's reaction to (a) an environmental change, e.g., a gust of wind, a magnetic storm; (b) numerical errors inside control loop of the drone itself, e.g., the imperfection of converting from speed of rotation to the exact targeted pitch, roll, yaw angles; and (c) by the vibration caused by propeller's movement, and the like. Embodiments of the invention leverage these undesirable yet persistent movements as unique signatures of drones, which can be used to differentiate a drone from other moving objects. The movements of interest fall into two main categories: the drone's body shifting and body vibration.

### Drone Body Shifting

Body shifting happens as a sequence of discrete events. FIG. 5 illustrates the drone's body movement caused by wind (a, b) as the result of a rebalancing effort from the drone's controlling mechanism (c, d). Beside the drifting due to the effect of environmental conditions, the drone body also usually changes its body orientation and direction when it flies. The angular velocity of the rotor i, denoted ωᵢ, creates force Fᵢ in the direction of the rotor's axis. The angular velocity and acceleration of the rotor also need to create torque τMᵢ around the rotor axis: Fᵢ=kωᵢ², τMᵢ=bωᵢ²+I_{M}ωᵢ* in which ωᵢ is the rotation speed of rotor i, k is the lift constant, b is the drag constant, the inertial movement of the rotor is I_{M}. The impact from ωᵢ* is usually small and, thus, it is omitted. When the wind creates an additional force changing the balance of the drone, the drag force now becomes τMᵢ+ΔF₁. To make the drone return to a stable state, the propeller on the right side will speed up to create an additional force ΔF₂, (ΔF₁≈ΔF₂) against the force generated by the wind. When the drone is balanced, if the additional force ΔF₂ stays longer than expected, it creates a side effect to the drone body that makes the drone unbalanced again. Next, the controlling algorithm will change the propeller speed expecting the drone to go to the balanced state. This process will be repeated and take several iterations until the drone reaches its equilibrium. FIG. 5 illustrates the expected movement pattern when such a body shifting phenomenon happens. Applicant considers this behavior to be one signature of a flying drone that can be used to distinguish it from other flying objects, e.g., birds. This waveform resembles a wavelet.

### Drone Body Vibrations

The drone body is vibrated within a certain frequency range and such vibrations are usually caused by the rotation of its propellers. The resulting vibration is the vector sum of vertical, longitudinal, and lateral vibrations. More specifically, in forced vibration, the frequency of the vibration is close to the frequency of the force or motion applied, and the magnitude of the vibration depends on the actual mechanical system. The steady-state solution of the forced vibration system with damping subjected to a sinusoidal force F(t)=F sin(2πft) can be expressed as x(t)=X sin(2πft−ϕ) where x(t) is the vibration function, X is the amplitude of the vibration, f is the vibration frequency, which is the same as the engine operating speed, and ϕ is the phase.

### Preliminary Validation of Drone Body Movements

This section presents a set of experiments to validate the signatures of the drone as mentioned earlier. Applicant conducted two main experiments to explore the body movement characteristics of the drone using (1) inertial measurement units (IMUS) and (2) a wireless sensing hardware. In the first experiment, Applicant attached external IMUs to the drone's frame underneath each propeller to capture the drone's body movements. Secondly, Applicant also firmly attached a 2.4 GHz wireless transmitting antenna to the drone. The RF signal from the transmitter was captured by a wireless receiver placed 2 meters apart. The goal was to validate whether the drone body movements are observable by analyzing the received wireless samples. Experimental results presented herein were performed on a PARROT BEBOP™ drone in an indoor environment. Similar confirmation was obtained using a DJI PHANTOM™ drone.

Validating Drone Body Movements using IMUs

Applicant inspected behaviors of the drone including taking off, hovering, and flying. The drone was augmented with 4 IMUs (MPU 9150 from SparkFun Electronics of Niwot, Colo.) each of which was mounted under each propeller. The data from these IMUs were gathered by an ARDUINO® Pro Mini board and then are sent to a computer via BLUETOOTH® Module HC-05. A camera was also used to record the start, the end, and the movement of the drone during testing sessions.

The objectives of the experiments were to answer the following questions. First, does the drone vibrate and move its body when flying as predicted in the previous analysis? Second, what are the frequencies of such vibrations and movement patterns? Third, when there is no wind, will the drone body shifting still persist?

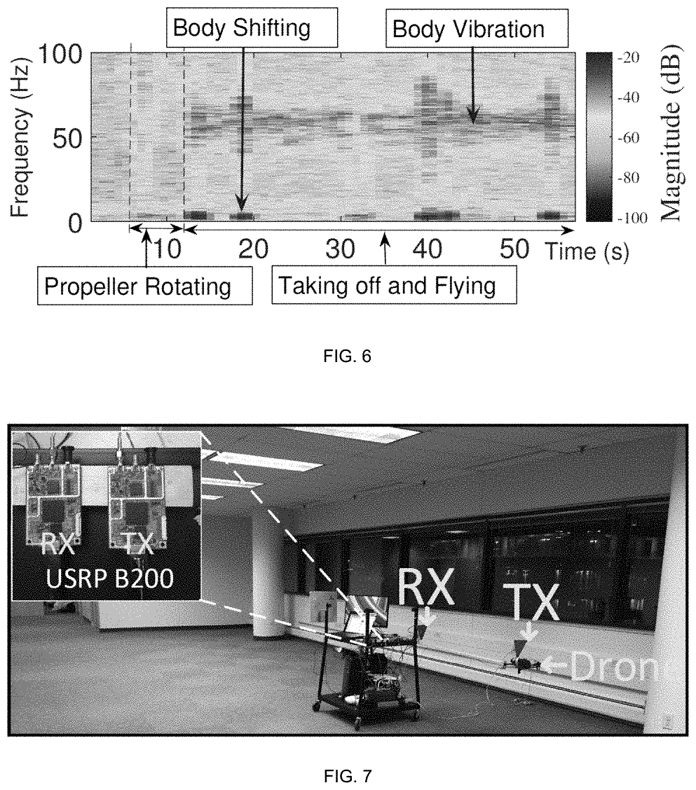

The spectrogram of the collected signal is shown in FIG. 6. There are two dominant frequencies that are observable from the data. The low frequency (less than 10 Hz) components occur at 10, 20, 32, 40, and 53 s, which correspond to the drone's body shifting (confirmed from recorded videos). In addition, the second dominant frequency at 50th to 70th Hz represents the vibration frequency of the drone body caused by propellers. These results answer the first two questions mentioned above: the drone constantly vibrates and creates iterative body shiftings when it flies

To answer the third question, Applicant set up a closed indoor experiment where wind is blocked to a minimal level and the drone circles within a small room. Analyzing the captured IMU data in both time and frequency domain yields two conclusions: the drone body vibration is still present from the IMU data even without wind and the body shifting still happens during the time the drone tries to adjust its pitch and yaw angles to fly in a circular shape. Such drone body movements happen when the drone tries to change its pitch, roll, and yaw angles. In summary, Applicant empirically confirmed that the drone body is shifted even in a windless environment, and the drone body continuously vibrates when it flies.

Feasibility Check: Capturing Drone Body Movements using RF Signals

Applicant conducted a second set of experiments to check the feasibility of capturing the drone movements using RF signals. A wireless transmission antenna was attached to the drone.

A wireless receiving antenna is placed at a fixed location to capture the signal sent from the transmitter (which was attached to the drone as illustrated in FIG. 7). Applicant used USRP B200 mini software-defined radios (SDR) to control the transmitter and receiver antennas. The antennas are connected to USRP SDRs through cables of 6 m length. The transmitter antenna emits a single tone wireless signal at 2.4 GHz when the drone is flying. The key idea is to capture the change in RSSI (received signal strength indicator) and phase of the transmitted single tone signal to infer the drone body movements. In addition, Applicant also attached the IMUs to the drone and collect the data as to the ground truth. The objectives of this experiment were to answer the following question: do received wireless samples correspond to the movements of the drone for body shifting and for body vibration?

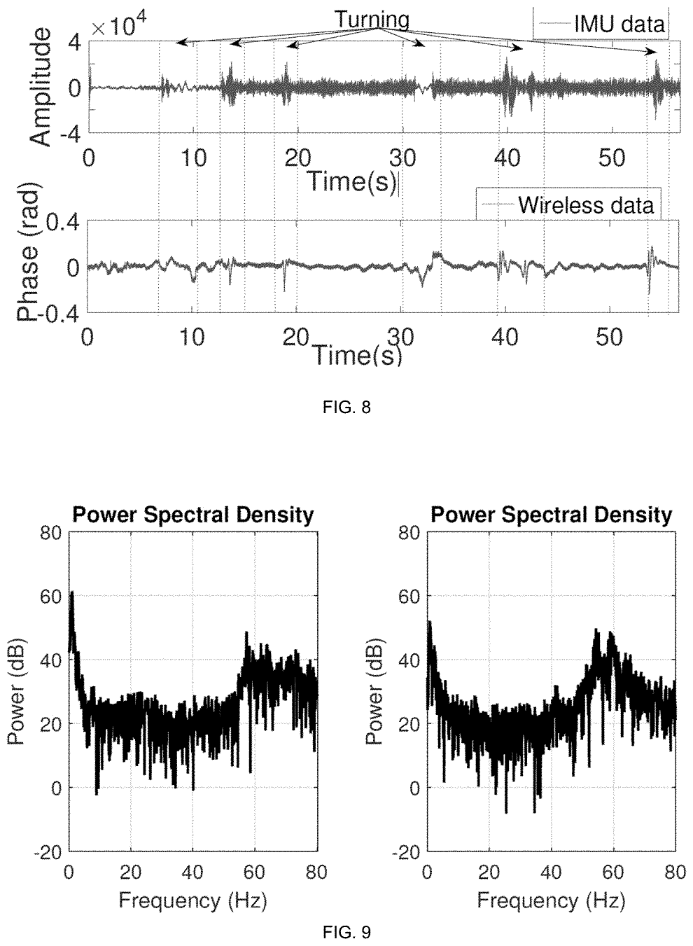

The results showed that it is possible to capture body shifting and body vibration in the RF domain. First, in FIG. 8, Applicant plotted the raw data obtained from accelerometer data and the phase of the received RF signal. Note that the SDR listens to a WI-FI® band and demodulates the signal to baseband, after which Applicant computed the FFT. As shown in the figure, the body-shifting peaks corresponding to turning are clearly identifiable and correlated on both accelerometer and RF data.

Applicant conducted experiments to see whether the measured vibration frequency of the IMU matches that seen in the frequency domain of the RF signal. Applicant confirmed that the peak frequency detected in the frequency domain repeatedly matches that observed via the IMUs. FIG. 9 illustrates the frequency distribution of RF signal captured with peaks around the 60 Hz mark, which is similar to the peak on the IMU measurements.

### Drone Presence Detection

Applicant designed a system that detects the above-mentioned body movements, namely body shifting and body vibration, by passively listening on the radio channels that the drone is using to communicate with its remote controller. A number of algorithms are introduced to capture such miniature physical signatures and to identify if it is coming from a drone.

### Problem Formulation

To detect the presence of drones, embodiments of the invention listen to the channel that is used by the drone to communicate with its remote controller. Let the signal broadcast by the drone to its remote control be \tilde{t}(t) at time t. The signal received by listening is \tilde{r}(t). Because the movements of interest are at frequencies that are a few orders of magnitude lower than the carrier frequency or the data rate, \tilde{r}(t) can be filtered to obtain only the low frequency components. Let \tilde{r}_{f}(t) be the filtered signal. This yields:

\tilde{r}_{f}(t)=q(t)+η(t) (1)

where q(t) is the signal that contains the drone body shifting and body vibration, and η(t), which is the environment noise. After removing the DC components, η(t) becomes a signal with zero-mean and some variance. Previous experiments show that the drone body vibration happens continuously over a specific range of frequencies when the drone is flying. In addition, Applicant also found that the drone body shifting has a form that is close to a wavelet ψ(t) due to the characteristic of its rebalancing and control loop mechanisms. Hence, the drone signal q(t) can be written as:

\tilde{r}_{f}(t)=ψ(t)+X sin(2πft+ϕ) (2)

where ψ(t) is the function represents the drone body shifting. ψ(t) is the function containing different dominant single-tone cosine signals that have amplitude Â(ψ), frequency \hat{f}(ψ), and phase \hat{ϕ}(ψ). And X, ϕ, and f are the amplitude, phase, and frequency of the drone body vibration. In summary, the objectives of embodiments of the invention include identifying the drone body shifting (Â(ψ), \hat{f}(ψ), \hat{ϕ}(104 )) and the drone body vibration (X, ϕ, f).

However, accurate and robust drone detection based on RF signals is challenging due to the following challenges.

First, the drone body shifting and movement information are buried in the wireless signal. This limits the maximum detection range that can be obtained from the system at different environment.

Second, the body shifting can happen at different scale. Different drones creates different type of body shifting according to their controlling mechanism and accuracy as well as their physical characteristics (weight, structures, and etc.). The signal can be detected at different magnitudes as well as frequencies. However, the shape of the body shifting signal stays relatively constant. Embodiments of the invention utilize a wavelet-based technique that is resilient to the scale and magnitude of the physical body shift.

Third, the drone may communicate at the same frequency channel with the wireless APs in the environment. The detection algorithm should be able to distinguish between the signals from the static APs and the signal from the drone. The solution for the next challenge is used to solve this problem.

Fourth, a mobile AP carried by a human walking or an embedded AP on a moving vehicle (e.g., a bus) could create similar wireless signals as the drone, which could affect the detection results (assuming the AP operates at the same frequency with the drone's communication channel). Embodiments of the invention utilize a technique that differentiates the drone from other static or mobile APs based on identifying the body vibration of the drone using RF.

Fifth, the noisy and heterogeneous environment makes the problem much more challenging. Embodiments of the invention introduce an evidence-based classifier to make the detection more robust. The drone presence is detected based on the availability of multiple lines of evidence that uniquely identify the physical characteristics of the drone (body shifting and body vibration).

Sixth, drones vary in terms of having different numbers of propellers, weights and sizes, speeds, and communication mechanisms. Applicant presents a confusion matrix showing that the detection approach is promising in terms of discriminating among the specific set of drones tested.

### Drone Detection Algorithm

Because drone body shifting happens at different scales and environments, it can be detected at different magnitudes as well as frequencies. However, the shape of the signal stays relatively constant. Embodiments of the invention utilize a wavelet-based technique that is resilient to the scale and magnitude of the physical body shift. In addition, Applicant provides a Fourier analysis to detect the drone body vibration. Further embodiments provide an evidence-based algorithm taking the input from wavelet and Fourier analysis to make the final decision.

### Drone Body Shifting Detection

Embodiments of the invention use wavelet analysis to detect the drone body shifting. A wavelet is a wave-like oscillation with an amplitude that begins at zero, increases, and then decreases back to zero. Wavelets are especially good at capturing brief oscillations. From the results of the experiment discussed in the “Body Shifting and Body Vibration as Drone's Physical Signatures” section herein, the behavior of the drone body shifting is similar to the form of a wavelet. This characteristic will result in high coefficients when multiplying the wireless signal \tilde{r}(t) with scaled versions of the mother wavelet.

The wavelet, denoted by ω(t), maintains local information in both the time and frequency domains. It is defined as a waveform that satisfies the following condition: ∫_{-∞}^{+∞}ω(t)dt =0. The wavelet transform uses as the wavelet that satisfies the condition of dynamic scaling and shifting function, ω_{s,p},

$${ω}_{s , p} ( t ) = \frac{1}{\sqrt{s}} ω ( \frac{t - p}{s} ) \qquad ( 3 )$$

where ω_{s,p}(t) are the integrated and integral transformation signal, s is the scale, and p is the shift parameter, which can also be the central location of the wavelet in the time domain. The wavelet can be stretched and translated with flexible windows by adjusting s and p, respectively. The wavelet transform of the wireless received samples ˜r(t) using transform coefficient W(s,p) is calculated as following:

$$W ( s , p ) = {\int }_{- ∞}^{+ ∞} ( t ) \overline{{ω}_{s , p}} ( t ) d t = \frac{1}{\sqrt{s}} {\int }_{- ∞}^{+ ∞} ( t ) \overline{{ω}_{s , p}} ( \frac{t - p}{s} ) d t \qquad ( 4 )$$

where ω̅_̅{̅s̅,̅p̅}̅(t) represents the complex conjugate of ω_{s,p}(t). The result of the wavelet transform gives a correlation function of the template signal at different scales (frequency bands) in both the time and frequency domains. As in Equation (4), the correlation function W_{s,p}(t) has two main features as follows. First, the time resolution is high with high frequencies while the frequency resolution is high with low frequency signals. When multiplying the high frequency component of the signal with the high frequency of the wavelet, the correlation result will indicate the exact location where it happens. This can be used to identify the very first body-shifting event created by the drone when it is flying in the coverage area. Second, as the wavelet has local existence in both time and frequency domain, the point of discontinuity in the signal can be detected with high sensitivity. As the discontinuity (generated by body shifting) is considered as an event and happens quickly in time, the result of correlation with high frequency wavelet will be readily captured.

Let Wₘ(s,p), Wᵥᵢ(s,p), and W_{η}(s, p) be the wavelet transform coefficients of the signal caused by the drone body shifting, drone body vibration, and the noise, respectively. The wavelet transform coefficient of the sum of the signals is calculated as follows:

W_{m+vi+η}(s,p)=Wₘ(s,p)+Wᵥᵢ(s,p)+W_{η}(s,p) (5)

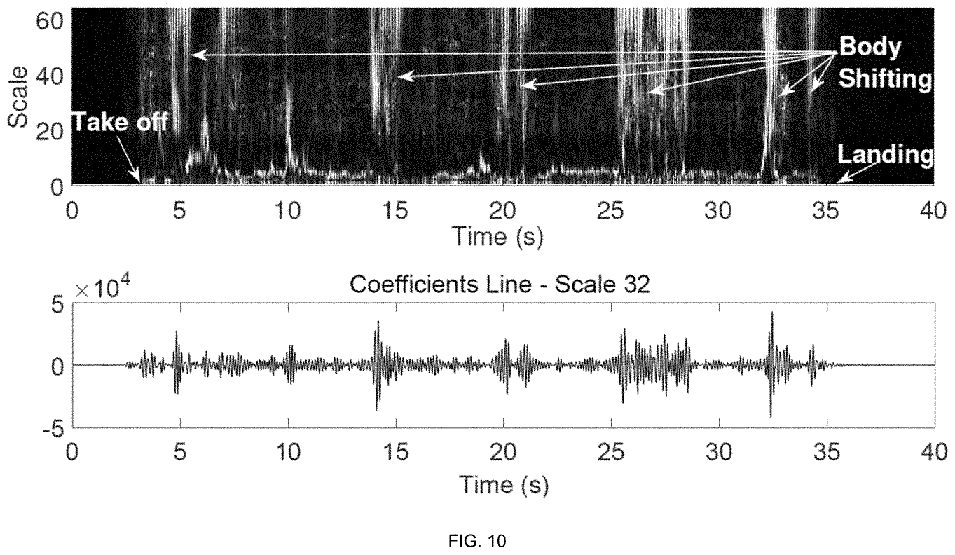

Because of the linearity property, the coefficients of the wavelet transform enable precise identification of the body shifting event in the time domain when there is a signal discontinuity. As the drone body vibration and the noise are quite constant over time, these behaviors decay quickly after different levels of scaling, leaving the body shifting component. The wavelet transform coefficients then yield two valuable pieces of information for event detection: the location and the duration of each body shifting event. FIG. 10 (top panel) depicts the results of the wavelet transform at 64 scales of the received wireless samples. The drone body shifting events are correctly identified.

However, as the wavelet transform is very sensitive to discontinuities in the signal, false alarms might be created when those discontinuities are due to other mobile APs carried by humans or embedded on moving vehicles. To overcome this problem, further embodiments provide a method to analyze the body shifting frequency combining wavelet and Short-Time Fourier Transform (STFT) analysis that uses wavelet transform to decompose the signal into a series of sub-frequency bands. The sub-frequency band that contains the main body-shifting frequency can be used to extract the frequency range in time and define a frequency range that most suitable for window size of STFT.

The procedure of the proposed method is as follows. First, the system decomposes the signal into a sequence of sub-frequency bands and approximates the energy of each frequency band, finding the ones that have enough energy and reconstructing them. The system then analyzes the specific frequency band that contains the main frequency component of the body shifting. Each sub-frequency band's energy is calculated as following:

$${ξ}_{i} = \int {\vert {f}_{i} ( t ) \vert}^{2} d t = {\sum }_{k = 1}^{n} {\vert {f}_{i} ( k ) \vert}^{2} \qquad ( 6 )$$

where fᵢ(t) is the signal of i frequency band, fᵢ(k) is its discrete value. The system compares the energy of each frequency band, then reconstructs the coefficient of special sub frequencies that have enough energy and contain the frequency of drone body shifting.

The center of the signal can be calculated according to the definition of the gravitational center in mechanics, namely the center of the body shifting event in time is given as:

$${t}_{center} = \frac{\int t {\vert f ( t ) \vert}^{2} d t}{\int {\vert f ( t ) \vert}^{2} d t} = {\sum }_{k = 1}^{n} {\vert {f}_{i} ( k ) \vert}^{2} \qquad ( 7 )$$

Then, the width of the window function of the STFT can be calculated from the central point to the point where the coefficient value W_{s,p} drops down to the noise band. Hence, the above results yields the time center and the width of the function. One then can perform STFT to analyze the frequency of the drone body movement. The peak of the frequency distribution resulting from STFT identifies the frequency of drone body shifting ψ(t).

### Drone Body Vibration Detection

As seen in FIG. 6, the drone's vibration creates a periodic signal that is well-reflected in the FFT-based spectrogram. Conversely, a wavelet transform that is better-suited for capturing transitory phenomena such as a body shifting event is not well-suited for drone vibration detection. Embodiments of the invention employ a frequency domain approach to identifying the presence of the drone's vibration signal. Recall that the wireless signal component that is affected by the drone body vibration has the form of X sin(2πft +ϕ). From the received wireless sample \tilde{r}(t), an efficient approximation of the drone's vibration frequency is to identify the dominant frequency component that has maximum power spectrum density (PSD) through the STFT. Then, the approximation of the drone's vibration frequency fᵥ is as follows:

$${f}_{v} = {max}_{[ {f}_{min} \to {f}_{max} ]} ( {\vert {\sum }_{k = 1}^{N} ( t ) {e}^{- j 2 π ftk} \vert}^{2} ) \qquad ( 8 )$$

where N is the number samples. After f is estimated, it can be used to estimate the amplitudes and phases of different frequency channels using

$$X = \frac{2}{N} \vert {\sum }_{k = 1}^{N} ( t ) {e}^{- j 2 π f t k} \vert and ϕ = {tan}^{- 1} \frac{- {Σ}_{k = 1}^{N} ( t ) sin ( 2 π f t k )}{{Σ}_{k = 1}^{N} ( t ) cos ( 2 π f t k )} .$$

In this way, the system obtains the desired quantities [X, ϕ, f].

### Evidence-Based Drone Detection Algorithm

We design an algorithm to determine if a drone is present by first gathering evidence from multiple sources that related to the drone body shifting and vibration, then combine these sources of evidence to form a binary classifier.

Evidence #1—Moving Object—The first evidence is the presence of a moving object using RF signals. This is not a unique indication of a drone but of any moving object such as a human walking while carrying a phone or a phone inside a car. Embodiments of the invention calculate the standard deviation of the received wireless signal and compare it with the standard deviation of the environment at the time of initialization. The standard variation of the signal without moving objects, denoted by δ₀ is an environment independent quantity and it represents the received signal changes caused by electronic noise. Received signals are dominated by quantization errors and electronic noise. Therefore, the signal follows a Gaussian distribution with zero-mean after DC removal. On the other hand, when the drone or other moving object is in the environment, the received signals are expected to follow the distribution of multipath fading because it dominates the other noise sources. A log-normal, Ricean, or Rayleigh distribution is expected with such multipath affects. As a result, the comparison between the standard deviation of the signal at test and δ₀ can be done to confirm this evidence.

Evidence #2—Drone Body Shifting—As mentioned in the “Drone Body Shifting Detection” section herein, the drone body shifting event serves as one of the main indications of drone presence detection. Because the shifting follows a certain pattern in space, it can be amplified and detected using wavelet transformation. Embodiments of the invention use Mexican hat wavelet as discussed in L. K. Shark & C. Yu, “Design of Matched Wavelets Based on Generalized Mexican-hat Function”, 86(7) Signal Process. 1451-69 (July 2006) as the template of comparison because this wavelet has a similar waveform to the drone's body shifting event shown before. The speed (i.e., how fast it shifts) and amplitude (i.e., how much it moves) of the shifting might vary from one movement to another. Therefore, embodiments of the evidence confirmation method can be designed to detect a specific range of speeds (i.e., frequency) and amplitudes (i.e., wavelet scale). Embodiments of the invention utilize a two-step process for confirming the body shifting by looking at the signal from both frequency and wavelet domains. In particular, embodiments of the invention acquire the frequency of the body shifting as shown in the “Drone Body Shifting Detection” section herein. Embodiments of the invention then compare the waveform of the shifting with the template by calculating the coefficient between the two using the Dynamic Time Wrapping technique, e.g., as discussed in T. Giorgino, “Computing and visualizing dynamic time warping alignments in R: The dtw package”, 31(7) J. Statistical Software 1-24 (2009) and P. Tormene et al., “Matching incomplete time series with dynamic time warping: An algorithm and an application to post-stroke rehabilitation”, 45(1) Artificial Intelligence in Medicine 11-34 (2008). The evidence can be confirmed when the frequency is less than 5 Hz and the coefficient is under a preset threshold. This threshold can be determined by the practical possible range of body shifting amplitude.

Evidence #3—Coefficient Invariance—This evidence confirms that the body shifting is a discrete event that is similar to the template. The intuition for this evidence stems from the fact that body shifting movements are unexpected and non-uniform events triggered by various environmental and electronic artifacts. As a result, two or more consecutive body shifting motions are not expected to be similar. As one of the wavelet transformation properties, coefficient invariance can show if a template is present on a trunk of signal once and only once. In particular, the coefficients are retained and even enhanced as the transformation scale increases as discussed in P. Chaovalit et al., “Discrete Wavelet Transform-Based Time Series Analysis and Mining” 43(2) ACM Comput. Surv. 6:1-6:37 (Feb. 2011) if the signal is of the template form and non-repetitive. The coefficient invariance evidence is confirmed if the coefficient magnitude monotonically increases as the transformation scale increases.

Evidence #4—Temporal Consistency—While the previous evidence (#3) can capture the discontinuity of an event, it could also introduce false alarms by counting short and discrete surges of signals caused by noises in the environment. This evidence is introduced to address this very issue. The key idea is to observe the spread of the signal at different sampling rates. As the sampling rate reduces, the coefficient of the noise (discrete surges) decays because the wireless samples that represent the surges are reduced or disappear. Let t₁ be the spread of the signal at sampling rate fₛ₁, t₂ be the spread of the signal at sampling rate fₛ₂, f₁>f₂. t₁ and t₂ can be approximated from the spread of the wavelet coefficient that is over the threshold. Wavelet decomposition as discussed in S. G. Mallat, “A Theory for Multiresolution Signal Decomposition: The Wavelet Representation”, 11(7) IEEE Trans. Pattern Anal. Mach. Intell. 674-93 (July 1989) can be used to collect this evidence. If t₁ and t₂ at two consecutive levels of decomposition are close to each other, the evidence can be confirmed.

Evidence #5—Event Singularity—As the fluctuation of the drone is in the wavelet pattern, the direction of fluctuation is very unique. The direction of the body shifting can be obtained by the sign of extremum of the wavelet coefficients. In one embodiment, the direction must be changed between two consecutive extrema at the same frequency with that of the body shifting at different levels of decomposition. To confirm the fluctuation is from the drone body, the sign of the extremum coefficient needs to alternate while the magnitudes of coefficients remain similar.

Evidence #6—Drone Body Vibration—As shown in the “Drone Body Vibration Detection” section herein, the drone body vibration is observable through a Fourier analysis. The evidence can be obtained when maximum power distribution of the peak frequency belongs to the range of drone's body vibration. This evidence can be used to identify the drone versus other interference sources such as mobile AP carrying by a walking user or the embedded AP on a moving bus.

The different forms of evidence can be collected at each time window. The decision can be made based on the number of forms of evidence that are confirmed on each window. Embodiments of the invention sort the evidence based on their uniqueness as the signature for drones. All the evidence is combined linearly for the final decision of detection. That is, embodiments of the invention conclude a drone is present only when all the forms of evidence are confirmed.

### Performance Evaluation

### Experimental Setup

An embodiment of the invention was implemented using the SDR USRP B200 mini. The USRP board was sampled at 100 kHz to collect wireless samples from the drone's communication channel. The USRP board was configured as a receiver connecting to an L-COM® 2.4 GHz 20 dBi gain antenna. The wireless samples collected from USRP were sent to a laptop for data processing and filtering. The WI-FI® channel of the drone's communication was identified by Wi-Fi Analyzer software available at https://play.google.com/store/apps/details?id=com.farproc.wifi.analyzer&hl=en. This application provides the channel ID and frequency for listening to the drone's communication. The collected data were stored in binary files and further processed using MATLAB® software.

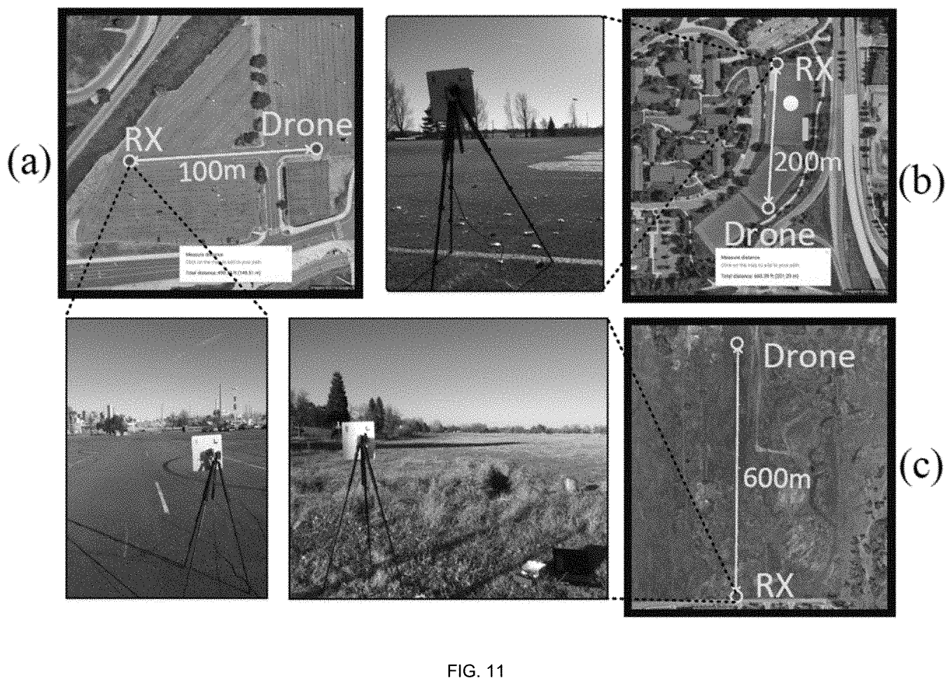

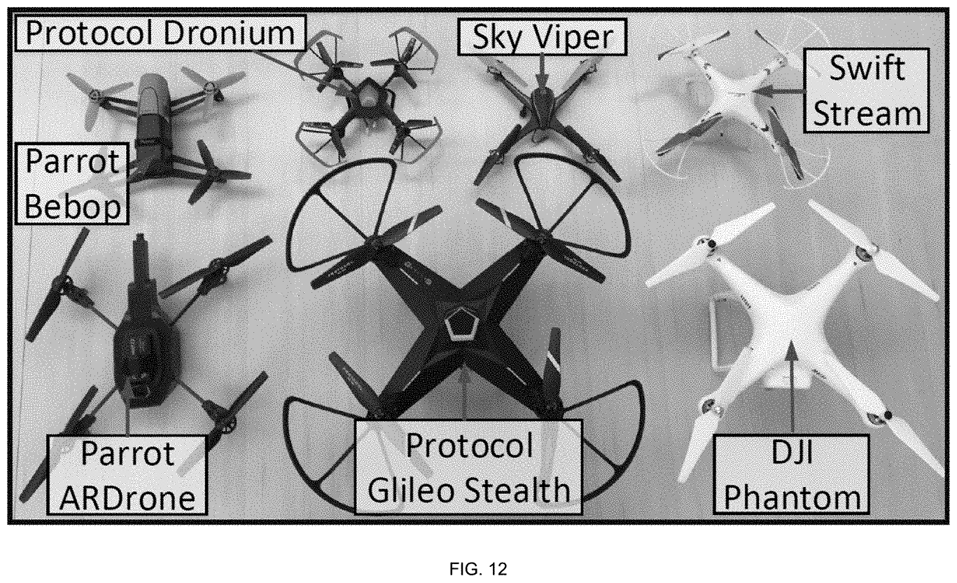

Applicant conducted experiments in three different environments including a parking lot in the downtown of a city (urban), a soccer field inside our university (campus), and an open field (sub-urban) as depicted in FIG. 11. In each environment, the data were collected when the drone was flying at different distances with respect to the receiver. Applicant collected data at the maximum distance of 100 m, 200 m, and 600 m in urban, campus, and sub-urban environments, respectively. The drone was controlled to take off and hover within the coverage area of the antenna receiver's beam.

The experiment was conducted on 7 different drones of different models and manufacturers as shown in FIG. 9, including the following brands: PARROT BEBOP™ PROTOCOL DRONIUM ONE SPECIAL EDITION™, SKY VIPER®, SWIFT STREAM™,

PARROT AR DRONE®, PROTOCOL GALILEO STEALTH™, and DJI PHANTOM™. The PARROT BEBOP™, PROTOCOL DRONIUM ONE SPECIAL EDITION™, SKY VIPER®, PARROT AR DRONE®, and DJI PHANTOM™ drones send WI-FI® signals from the WI-FI® card mounted on their body for either controlling the channel or streaming video. The PROTOCOL GALILEO STEALTH™ and SWIFT STREAM™ drones emit WI-FI® signals from the plug-n-play cameras distributed with the drones.

To test whether the drone's RF signal could be differentiated from those of other mobile wireless devices, Applicant also evaluated two other scenarios when a mobile AP was carried inside a moving vehicle or by a walking person. First, the user configures a mobile device to create a hotspot (mobile AP) to emit WI-FI® signals. Applicant used another mobile phone (client phone) to connect to the mobile AP. The client phone streams YOUTUBE® video continuously. Applicant asked the user to carry both the client and the mobile AP to walk around at a distance of 50 m away from the wireless system. Secondly, the client and mobile AP are placed inside a car which moves around in the coverage area of the wireless system at a distance of 50 m to 100 m away. The vehicle is moving at 20 mph speed. In both scenarios, the mobile AP and client are always within the coverage area of the system.

Applicant then segmented the collected data into two main types: drone and no drone. Each segment has a length of 10 seconds. The “drone” data contains the wireless segments that correspond to the moment where the drone is flying in the environment. Similarly, the “no drone” data contains the wireless segments that correspond to the moment at which there is no drone in the environment (i.e., the drone is completely turned off). More specifically, the “no drone” data contains types of data including “environment noises”, “human carrying AP”, and “mobile AP augmented inside a car”. For testing, Applicant used equal amounts of data for ‘drone” and “no drone”.

### Evaluation Results

Applicant evaluated performance at different distances (from 10 m to 600 m), with 7 different types of drones, and at different environmental setups (urban, campus, sub-urban). Applicant used accuracy, precision, and recall as the performance metrics for evaluation. The accuracy, precision, and recall are calculated from True Positive (TP), True Negative (TN), False Positive (FP), and False Negative (FN). The calculations are given as follows:

$$accuracy = \frac{T P + T N}{T P + F P + F N + T N} , precision = \frac{T P}{T P + F N} , and$$

$$recall = \frac{TP}{TP + FN} .$$

Detection Performance vs. Number of Evidences

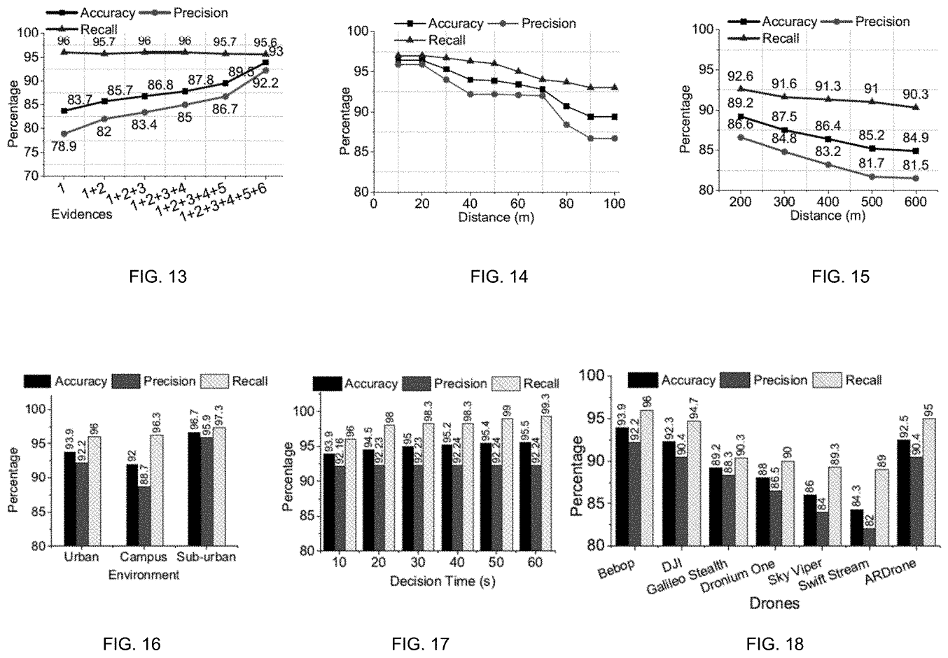

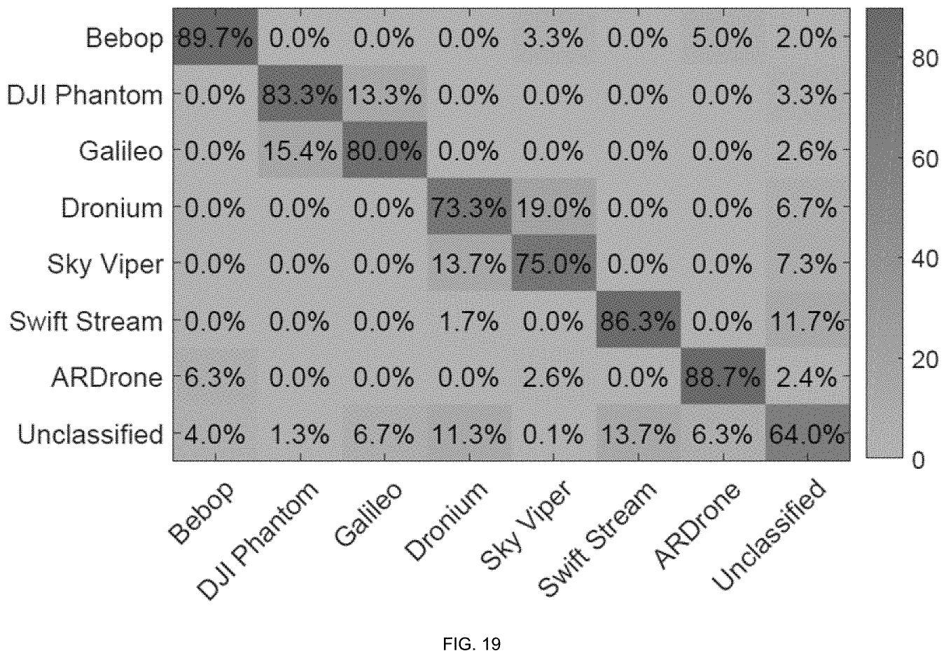

As mentioned in the “Drone Presence Detection” section herein, embodiments of the invention make detection decisions by collecting evidences that are resulted from its analysis of the collected wireless samples. Applicant ran the evaluation on the segmented data set of 600 segments of 10 seconds data (300 segments of drone's presence and 300 other segments from the environment, human walker carrying mobile APs, and mobile APs inside a moving car). These data were collected when the PARROT BEBOP™ drone was at 50 m distance from the system. The performance of detection is shown in FIG. 13 in which the evidence IDs are corresponding to the IDs presented in the “Drone Presence Detection” section herein. As can be seen in FIG. 13, the accuracy of the system is as low as 83.7% when the system uses only the first form of evidence to detect the drone. However, when more evidences are combined, the performance increases significantly. The false positive rate diminishes and precision correspondingly rises as increasing evidence is used. Initially, the precision of the system is as low as 78.9% with only one part of evidence and increases successively to 86.7% once all the first five forms of evidence are considered. Finally, when the vibration detection is considered (evidence #6), the overall precision rises to 92.2% (corresponding with 93.9% of accuracy and 95.6% for recall). This result is obtained due to the fact that the last evidence is well-represented for the uniqueness of drone's body vibration in the environment.

### Impact of Distance

Applicant also analyzed the impact of the distance between the detection system and the drone on performance. The evaluation was conducted for both short and long distances. At short distances, Applicant analyzed the performance of the system when the drone was from 10 m to 100 m away. Data from the PARROT BEBOP™ drone in the urban environment experiment is presented for this analysis. At each location, 600 segments of data are analyzed (300 segments of drone's presence). All 6 forms of evidence were used to calculate the results of detection. The results are shown in FIG. 14. The system obtained up to 96:5% of accuracy, 95:9% of precision, and 97% of recall when the drone is 10 m away from the detection system. When the distance increases, the performance of the detection falls to 89:4% of accuracy, 86:7% of precision and 93% of recall at 100 m.

The system performance is further evaluated when the distance between the drone and the detection system is from 200 m to 600 m. Applicant used a sub-urban data set for this evaluation. Applicant used 200 segments (100 segments with drones' presence) at each distance to evaluate the system. FIG. 15 shows the performance of an embodiment of the invention at these longer distances. The system obtained 84:9% of accuracy, 81:5% of precision, and 90:3% of recall at 600 m distance. Applicant was limited to 600 m due to the space constraints of the testing location, but believes that embodiments of the invention are capable of performing at greater distances.

### Impact of Environmental Setup

Applicant also evaluated the impact of the environment noise on performance. Applicant used the 50 m data set from the PARROT BEBOP™ drone at three locations (urban, campus, and suburban) for this evaluation. The impact of mobile APs was also taken into account. One half of the data set were from the drone; the other half includes the data from the environmental noises and human carrying a mobile AP. Data from mobile APs inside the campus environment was not available due to campus rules. The results of drone detection are shown in FIG. 16.

Applicant used 600 segments of data and 300 segments from the drone's presence. The system obtained the best performance in the suburban environment, as this area has little effect from environmental noise as well as multi-path reflection. The system can achieve up to 96:7% of accuracy, 95:9% and 97:3% of precision and recall, respectively. The campus environment has a number of wireless access points operating over different WI-FI® channels, and hence it was found that the drone communication channel usually interferes with other static APs in the campus environment. At the time of the experiment, there were 16 Wi-Fi APs in the same vicinity using the Wi-Fi Analyzer app. Therefore, the system creates more false alarms (false positive) in the campus environment compared with urban and sub-urban environments. However, an embodiment of the invention still achieved 92% accuracy, 88:7% precision, and 96:3% recall in the most interfering environment (campus).

### Impact of Time Budget

Detecting the drone is also challenging due to the limited time budget within which the drone flies across the detection system. Applicant was interested in analyzing the detection accuracy with different time budgets for detection. The key motivation is to understand the performance when the drone stays longer inside the coverage area. Applicant used the data set from the PARROT BEBOP™ drone at 50 m distance in an urban environment for this evaluation. Applicant used 600 segments of data with 300 segments from the drone's presence. Applicant increased the duration of each measurement (segment) from 10 s to 60 s, and a decision was made for each segment. FIG. 17 shows the performance obtained for different time budgets. An embodiment of the invention obtained up to 95:5% of accuracy with 60 s budget of detection. The accuracy and recall increase with more time to make a decision, unlike the precision.

### Performance Across Different Drones

Applicant evaluated performance for different types of drones including PARROT BEBOP™, PROTOCOL DRONIUM ONE SPECIAL EDITION™, SKY VIPER®, SWIFT STREAM™, PARROT AR DRONE®, PROTOCOL GALILEO STEALTH™, and DJI PHANTOM™. The PROTOCOL GALILEO STEALTH™ and SWIFT STREAM™ and some small drones in the market are usually configured at a specific frequency that does not belong to any WI-FI® channel. These drones are very light-weight and cannot carry much weight. They usually utilize a WI-FI® camera for video streaming and navigation. As the camera is attached to the drone, the wireless signal emitted by the WI-FI® camera would be very similar to the controlling signal from the drones if there is no shock absorbing mechanism is in-place for the camera. Applicant found that it is the case in this experiment.

FIG. 18 shows the accuracy of detecting different drones. An embodiment of the invention performs with the highest detection results for heavy drones such as PARROT BEBOP™, DJI PHANTOM™, PROTOCOL GALILEO STEALTH™, and PARROT AR DRONE®. Applicant found that those four drones generate similar signatures in body shifting as well as vibration frequency range. The PROTOCOL DRONIUM ONE SPECIAL EDITION™ and SWIFT STREAM™ drones are lighter. Applicant observed less vibration generated in the light-weight drones than the heavier ones, which explains the improved results for the heavier drones.

TABLE 2
Summary of Vibration Frequency (fᵥ) of Difference Drones

| Drone | fᵥ (Hz) |
|---|---|
| BEBOP ™ | 60 |
| DJI ™ | 100 |
| GALILEO ™ | 140 |
| DRONIUM ™ | 35 |
| SKY VIPER ® | 50 |
| SWIFT STREAM ™ | 20 |
| PARROT AR DRONE ® | 70 |

### Drone Classification

It is also important to identify which drone is flying in the coverage area after detecting its presence. Though not the focus of this work, Applicant explored its possibility. Applicant constructed a classifier based on the physical characteristics of the drones. One embodiment utilizes the frequency of vibration of each drone to detect/classify it. Drones are often uniquely designed in weight, structure, materials, propellers' size and so on. Those characteristics affect the forces generated by the propellers and therefore also affect the vibration frequency of the drones. Applicant employed a similar experimental setup as in the “Validating Drone Body Movements using IMUs” section herein. Applicant attached the IMUs to different drones to collect the motion data. The motion data was then analyzed to determine the central and the dominant frequencies of vibration. Applicant approximated the vibration frequency windows according to this central frequency as in Table 2.

### Discussion

Applicants system focused on detecting the presence of drones through their unique inherent physical movement signatures on WI-FI® domain. Embodiments of the invention can incorporate automated channel sensing, as the current experiments fix the eavesdropping to a specific communication channel. Such an approach should improve the ability to detect diverse drones that operate with different protocols over the same unlicensed WI-FI® frequency bands, or that communicate on non-WI-FI® frequency bands. Embodiments of the invention can also integrate automated antenna steering and/or beamforming, as the current experiments fix the direction of the antenna. Embodiments of the invention can also distinguish between individual drones as well as different types of drones. Further embodiments of the invention can also incorporate fusion algorithms such as boosting and bagging for combining multiple weak detectors into a stronger fused detector. In addition, embodiments of the invention can detect other aspects of the drone beyond merely its presence, such as its location, speed and direction. Still other embodiments of the invention can detect multiple drones in the same vicinity at the same time.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A device for passive detection of the presence of a drone, the device comprising:
an antenna;
a receiver in communication with the antenna to passively receive wireless signals; and
a processor in communication with the receiver and programmed to determine whether a drone is present based on a pattern in the wireless signals emitted from the drone that is correlated with a physical movement of the drone.

2. The device of claim 1, wherein the pattern is a unique signature of at least one of:
a drone's body vibration identifiable in the wireless signals; and
a drone's body shifting identifiable in the wireless signals.

3. The device of claim 1, wherein at least one of the receiver and the processor comprise at least one of:
a frequency-based detector programed to detect a maximum frequency peak in a defined range; and
a wavelet-based detector programed to detect shifts of the drone's body by computing wavelets at different scales.

4. The device of claim 1, wherein the processor is further programmed to differentiate drone signals from other mobile wireless devices based, at least in part, upon one or more patterns in the wireless signals emitted from the drone that is correlated with a physical movement of the drone.

5. The device of claim 4, wherein the processor is further programmed to differentiate drone signals with an accuracy, precision, and recall above 90 percent at 50 meters based at least in part upon the pattern in the wireless signals emitted from the drone that is correlated with a physical movement of the drone.

6. The device of claim 1, wherein the processor is further programmed to analyze the wireless signals to determine whether the wireless signals contain a pattern that is correlated with a physical movement of the drone.

7. The device of claim 6, wherein the processor is further programmed to confirm presence of a drone body movement by confirming presence of at least one selected from the group consisting of: a body shifting movement, a body vibration movement, a coefficient invariance, a temporal consistency, and an event singularity.

8. The device of claim 6, wherein the pattern is a unique signature correlated with a drone body movement.

9. The device of claim 8, wherein the drone body movement is a body-shifting movement.

10. The device of claim 8, wherein the drone body movement is a body-vibration movement.

11. The device of claim 8, wherein the processor is further programmed to confirm presence of a drone body movement by confirming presence of a body-shifting movement and a body-vibration movement.

12. The device of claim 8, wherein the processor is further programmed to confirm presence of a drone body movement by confirming existence of evidence of a body-shifting movement, a body-vibration movement, a coefficient invariance, a temporal consistency, and an event singularity.

13. The device of claim 12, wherein the processor is further programmed to:
weight two or more of the evidences to generate an aggregate probability that a drone is present, and
determine that a drone is present if the aggregate probability is greater than a defined aggregate probability threshold.

14. The device of claim 1, wherein the processor further programmed to make a determination based on physical movement of the drone reflected in a wireless signal, wherein the determination is at least one of:
localizing the position of the drone, wherein localizing comprises at least one of:
identifying a drone to be within a smaller range of a defined area;
determining the drone to be located along a particular direction in two- or three-dimensional space; and
determining the drone to be located along a particular location in two- or three-dimensional space;
determining the speed, direction, velocity, acceleration, and/or attitude of the drone;
distinguishing between individual drones;
distinguishing between different types of drones;
uniquely identifying a drone or drone type; and
detecting a number of drones in range.

15. The device of claim 1, wherein the processor is programmed to determine presence without using other methods of identifying the presence, location, direction, velocity, acceleration, or attitude of a drone based on audio, acoustic, video, infrared, thermal, active radar, simple RF detection in a 1 MHz to 6.8 GHz band, MAC-address collection and analysis, frequency of packet communications on uplink or downlink between a drone and its controller, WiDop, passive bi-static radar, and multi-static radar.

16. The device of claim 1, wherein the processor is programmed to determine presence using other methods of identifying the presence, location, direction, velocity, acceleration, or attitude of a drone based on audio, acoustic, video, infrared, thermal, active radar, simple RF detection in a 1 MHz to 6.8 GHz band, MAC-address collection and analysis, frequency of packet communications on uplink or downlink between a drone and its controller, WiDop, passive bi-static radar, and multi-static radar.

17. A method for passively detecting the presence of a drone, the method comprising:
receiving a wireless signal at a device comprising an antenna, a receiver and a processor; and
analyzing the wireless signal to determine whether the wireless signal includes a pattern in the signal that is indicative of a physical movement of a drone.

18. The method for detecting the presence of a drone of claim 17, wherein the pattern is a unique signature of at least one of:
a drone's body vibration identifiable in the wireless signals; and
a drone's body shifting identifiable in the wireless signals.

19. The method of claim 18, wherein the step of analyzing further comprises determining whether the wireless signals contain a pattern that is correlated with a physical movement of the drone.

20. The method of claim 19, wherein the physical movement is selected from the group consisting of: a body-vibration movement and a body-shifting movement.
